(19) United States
(12) Patent Application Publication
(10) Pub. No.: US 2003/0112622 A1
(43) Pub. Date: Jun. 19, 2003

(54) Combination tool kit

(76) Inventors: Wu-Lung Chu, Ta Li City (TW); Kun-Hsun Yu, Nantou Hsien (TW)

Correspondence Address: Keith Kline, PRO-TECHTOR INTERNATIONAL SERVICES, 20775 Norada Court, Saratoga, CA, 95070-3018, US

(21) Appl. No.: 10/025,253

(22) Filed: Dec. 17, 2001

(51) Int. Cl. B25B 23/18

(52) U.S. Cl. 362/109; 362/120; 362/119

(57) ABSTRACT

A combination tool kit is disclosed to include an elongated casing, a light emitting circuit assembly installed in the casing and controlled to emit light for illumination, the casing having a coupling head, the coupling head having a receiving hole adapted to hold a hex head socket or one of a set of cutting tools and a locating hole across the receiving hole, and a lock control member supported on a spring member in the locating hole and adapted to lock one cutting tool in the locating hole for working.

### BACKGROUND OF THE INVENTION

The present invention relates to a combination tool kit, and more specifically, to such a combination tool kit, which comprises an elongated casing for the holding of the hand, a light emitting circuit assembly mounted inside the casing and adapted to emit light for illumination, and a set of tool elements received in a rear receiving chamber of the casing for selectively fastened to a front coupling head of the casing for working.

When going to camp out in the wild open field, people may have to carry a variety of tools including knives, saws, screwdrivers, hand lamps, etc. It is inconvenient to carry a number of separated tools. There are commercially available combination hand tools. A Swiss army knife is one of the most popularly used combination hand tools, comprised of a scale and a variety of tool elements (including screwdrivers, hole punch, corkscrew, tweezers, toothpick, saws, scissors, spear blade, magnifier, etc., respectively pivoted to the scale. However, due to compact size, the tools of a Swiss army knife are inconvenient in use. Further, a Swiss army knife has no lighting means to provide illumination for use in the dark.

### SUMMARY OF THE INVENTION

The present invention has been accomplished under the circumstances in view. It is one object of the present invention to provide a combination tool kit, which can be alternatively set into a wrench or any of a variety of cutting tool for grasping and turning bolts and nuts, or for cutting or sawing things. It is another object of the present invention to provide a combination tool kit, which has lighting means to provide illumination for working in the dark. To achieve these and other objects of the present invention, the combination tool kit comprises a elongated casing convenient for the holding of the hand, a light emitting circuit assembly installed in the casing and controlled to emit light for illumination, the casing having a coupling head, the coupling head having a receiving hole adapted to hold a hex head socket or one of a set of cutting tools and a locating hole across the receiving hole, and a lock control member supported on a spring member in the locating hole and adapted to lock one cutting tool in the locating hole for working.

### BRIEF DESCRIPTION OF THE DRAWINGS

FIG. 1 illustrates the outer appearance of a combination tool kit according to the present invention.

FIG. 2 is an exploded view of the combination tool kit according to the present invention.

FIG. 3 shows different cutting tools of the tool element set according to the present invention.

FIG. 4 is one sectional assembly view of the combination tool kit according to the present invention.

FIG. 5 shows another sectional assembly view of the combination tool kit according to the present invention.

FIG. 6 is a sectional view of a part of the present invention, showing the hex head socket fastened to the hexagonal hole of the longitudinal receiving hole of the coupling head of the casing.

FIG. 7 is a sectional view of a part of the present invention, showing the lock control member moved to the unlocking position, the spring member compressed.

FIG. 8 shows an application of the present invention.

### DETAILED DESCRIPTION OF THE PREFERRED EMBODIMENT

Referring to FIGS. from 1 through 5, a combination tool kit is shown comprised of a casing 10, and a tool element set 20.

The casing 10 is an elongated member orthopedically engineered for the holding of the hand, comprising a coupling head 11 at the front side thereof, a light emitting circuit assembly 40 mounted on the inside, a receiving chamber 14 at the rear side thereof for receiving the tool element set 20.

The coupling head 11 comprises a longitudinal receiving hole 12, and a transverse locating hole 13 across the longitudinal receiving hole 12. The longitudinal receiving hole 12 is formed of a flat hole 121 and a hexagonal hole 122 and adapted to hold either of the tool elements 20. A locking device 30 is mounted in the transverse locating hole 13, and adapted to lock one tool element of the tool element set 20 in the longitudinal receiving hole 12. The locking device 30 is comprised of lock control member 31 and a spring member 32. The lock control member 31 comprises a knob 311, a locating block 313, and a neck 312 connected between the knob 311 and the locating block 313. The spring member 32 is fastened to the coupling head 11 of the casing 10 to support the lock control member 31 in the transverse locating hole 13 of the coupling head 11, enabling the lock control member 31 to be moved axially in the transverse locating hole 13 between the locking position and the unlocking position (this will be described further).

The light emitting circuit assembly 40 is comprised of a lamp bulb 41, and a battery 42. The lamp bulb 41 is mounted with the battery 42 in the casing 10 and controlled to emit light through the coupling head 11. According to the present preferred embodiment, the coupling head 11 admits light.

The tool element set 20 includes a hex head socket 22 adapted to grasp and turn any of a variety of bits, and a set of cutting tools 21. The cutting tools 21 each comprise a substantially S-shaped coupling notch 211 in the respective rear end. The coupling notch 211 has a neck 212. The width of the neck 212 is slightly greater than the diameter of the neck 312 of the lock control member 31. The inner side of the coupling notch 211 is greater than the diameter of the locating block 313.

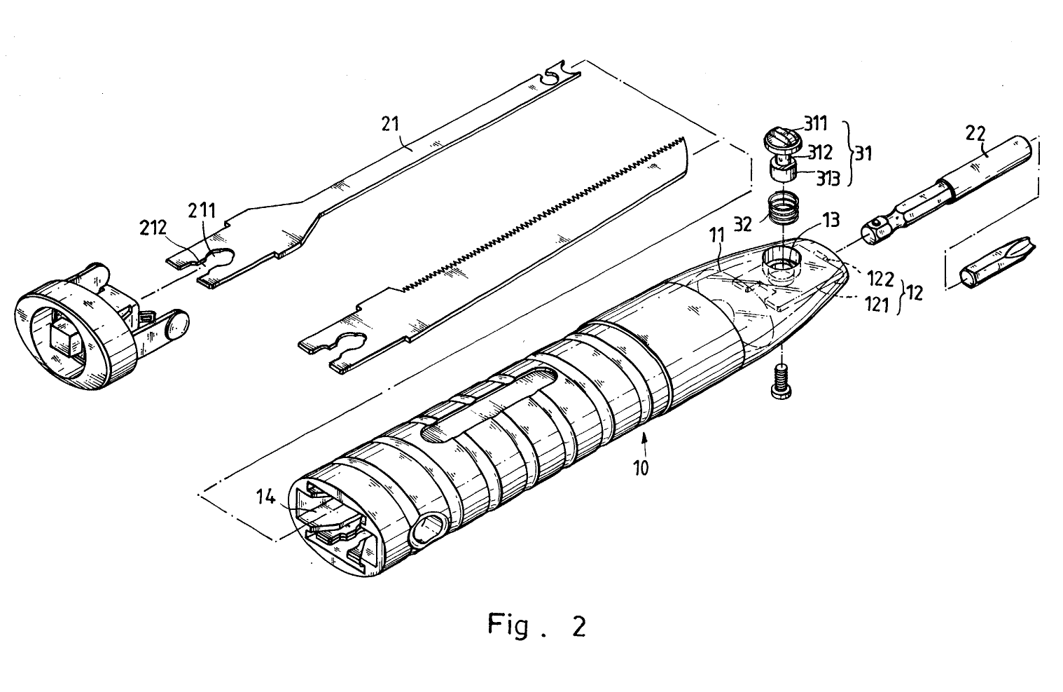

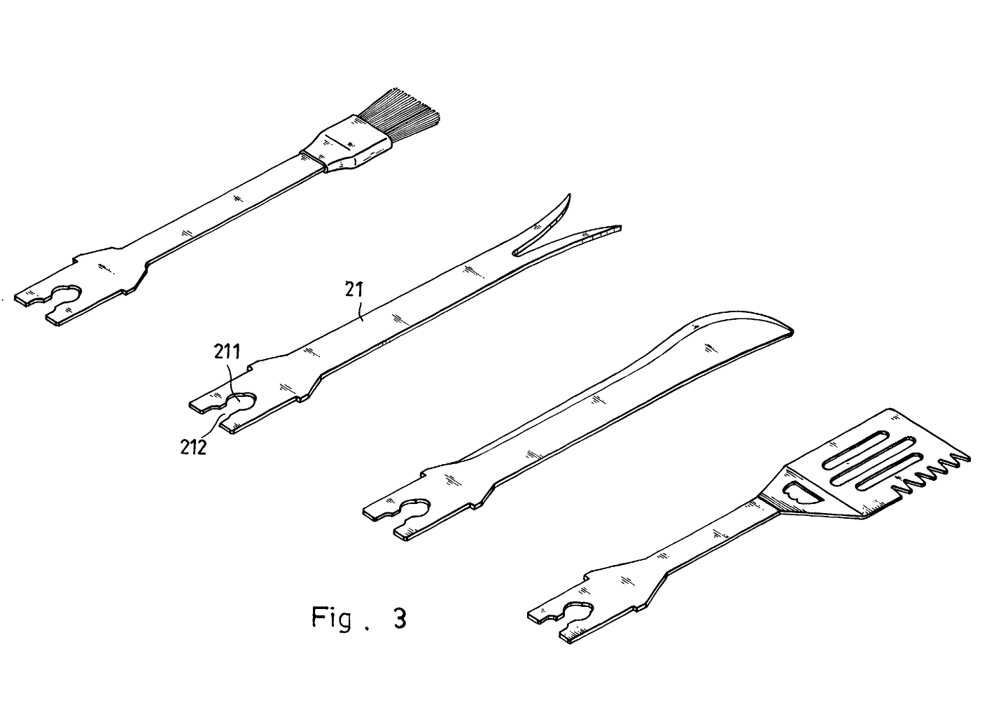

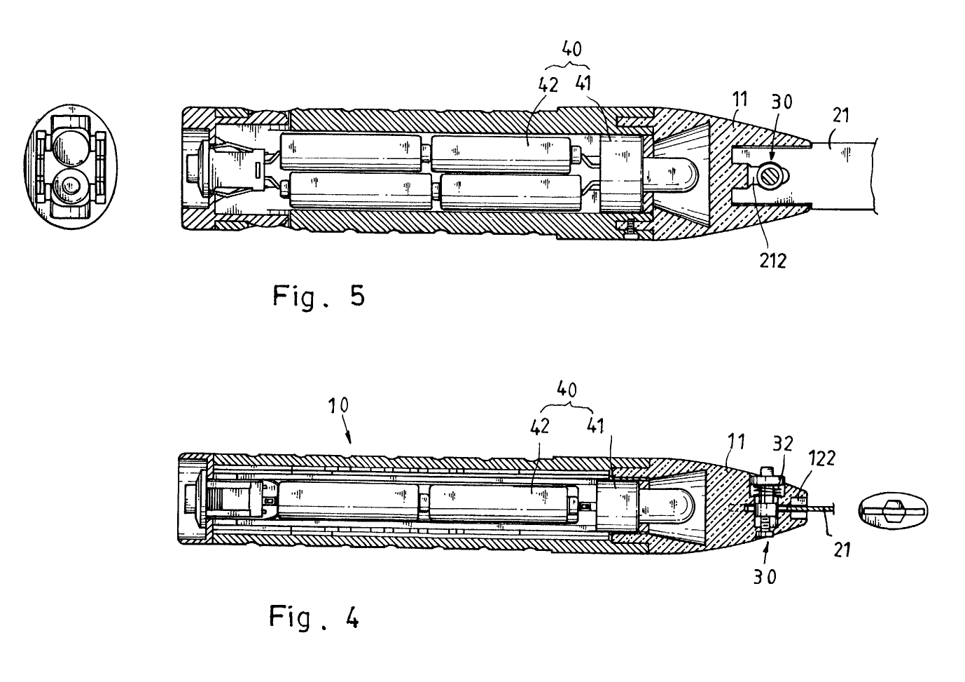

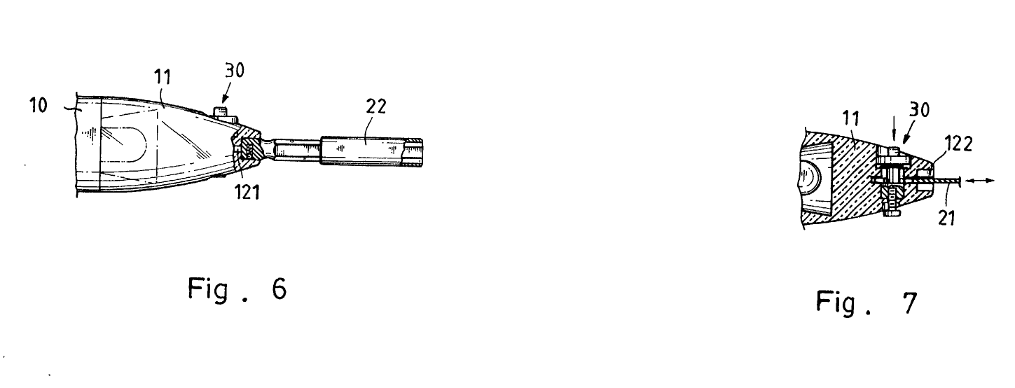

Referring to FIG. 6 and FIG. 2 again, the hex head socket 22 adapted to grasp and turn any of a variety of bits can be directly fastened to the hexagonal hole 122 of the longitudinal receiving hole 12 of the coupling head 11 of the casing 10 for grasping and turning a bit, for example, a screwdriver.

Referring to FIG. 7 and FIGS. from 1 through 5 again, when using or changing a cutting tool 21, the lock control member 31 is pressed downwards against the spring member 32, enabling the selected cutting tool 21 to be inserted into the flat hole 121 of the longitudinal receiving hole 12 of the coupling head 1 of the casing 10. After insertion of the selected cutting tool 21, the hand is released from the lock control member 31, enabling the spring member 32 to push the lock control member 31 to its original position. When pushed back to the original position, the neck 312 of the lock control member 31 is engaged with an inner side of the peripheral edge of the neck 212 of the coupling notch 211 to stop the inserted cutting tool 21 from forward movement relative to the coupling head 1 of the casing 10.

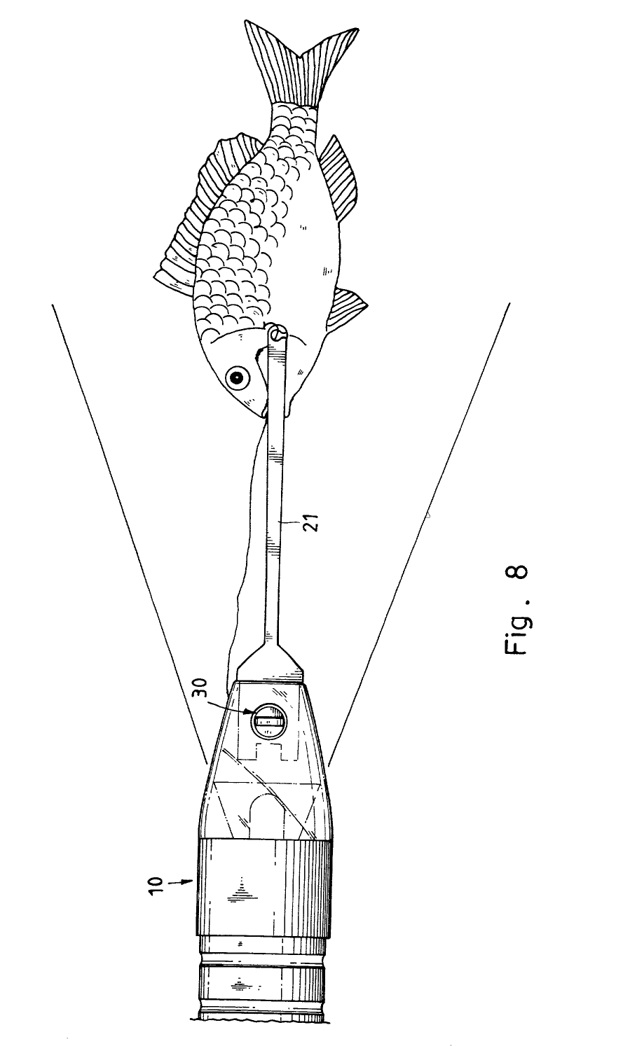

When using the combination tool kit in the dark, the light emitting circuit assembly 40 is switched on to emit light through the coupling head 11 of the casing 10 for illumination (see FIGS. 5 and 8).

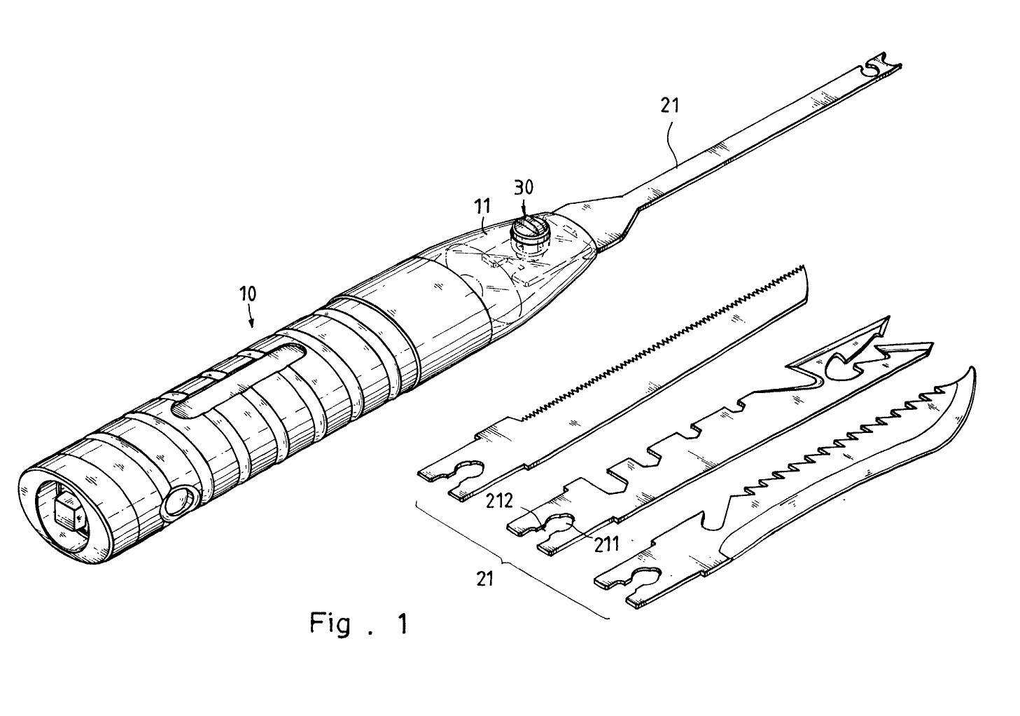

A prototype of combination tool kit has been constructed with the features of FIGS. 1˜8. The combination tool kit functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A combination tool kit comprising a:
an elongated casing for the holding of the hand, said casing comprising a coupling head at a front side thereof and a receiving chamber at a rear side thereof, said coupling head comprising a longitudinal receiving hole and a transverse locating hole across said longitudinal receiving hole, said longitudinal receiving hole formed of a flat hole and a hexagonal hole;
a light emitting circuit assembly mounted in said elongated casing and adapted to emit light through said coupling head, said light emitting circuit assembly comprising a battery and a lamp bulb electrically connected to said battery;
a set of tool elements received in said receiving chamber of said casing for selectively fastening to the longitudinal receiving hole of said coupling head; and
a locking device mounted in the transverse locating hole of said coupling head and adapted to lock one of said tool elements in said longitudinal receiving hole of said coupling head for working, said locking device comprising a spring member mounted in said transverse locating hole of said coupling head, and a lock control member supported on said spring member and moved in said transverse locating hole to lock/unlock the tool element being inserted in said longitudinal receiving hole of said coupling head.

2. The combination tool kit as claimed in claim 1 wherein said tool elements include a hex head socket and a set of cutting tools.

3. The combination tool kit as claimed in claim 2 wherein said cutting tools each comprise a substantially S-shaped coupling notch disposed in one end thereof for engagement with said lock control member of said locking device, said coupling notch having a neck; said lock control member of said locking device comprises a knob, a locating block, and a neck connected between said knob and said locating block for engagement with an inner peripheral edge of the neck of the S-shaped coupling notch of one of said cutting tools.
